(19) United States
(12) Patent Application Publication
(10) Pub. No.: US 2011/0051641 A1
(43) Pub. Date: Mar. 3, 2011

(54) Low Power Consumption Wireless Sensory and Data Transmission System

(76) Inventor: Yang Pan, Shanghai (CN)

(21) Appl. No.: 12/550,392

(22) Filed: Aug. 30, 2009

(51) Int. Cl. G08C 17/00

(52) U.S. Cl. 370/311

(57) ABSTRACT

A low power consumption wireless sensory and data transmission system is disclosed. The system comprises a plurality of data collection and/or storage devices (nodes) and an information collection apparatus. The devices and the apparatus are connectable through an ad hoc communication network. The devices (nodes) are at “switch-off” status until receiving a radio-frequency energy generated by and transmitted from the apparatus. A radio-frequency receiver converts the received energy into a direct-current voltage. A power supply starts to provide power for the operations of the devices if the direct-current voltage is in exceeding of a threshold value of a switch. Data collected by various sensors and/or readout from the storage of the devices are transmitted through the ad hoc network to the information collection apparatus.

### CROSS-REFERENCE TO RELATED APPLICATIONS

This application is related to the application Ser. No. 12/534,108.

### BACKGROUND

1. Field of Invention

This invention relates to an information collecting system, specifically to a low power consumption wireless sensory and data transmission network.

2. Description of Prior Art

Recently, much work has been directed towards the building of networks of distributed wireless sensor nodes. Sensor nodes in such networks conduct measurements at distributed locations and relay the measurements, via other data collection points. Wireless sensor networks, generally are envisioned as encompassing a large number of sensor nodes, with traffic flowing from the sensor nodes into a much smaller number of measurement data collection points through information collection apparatus. Sensor nodes are commonly equipped, for example, with sensors, a local storage unit, a processor and wireless communication devices. Such sensor nodes are typically small and the communication devices are typically short range communication transceivers that form an ad hoc communication network.

Generally, the sensor nodes have one or more of the following characteristics: a) the nodes are desired to operate for extended periods of time on battery power; b) the nodes have limited computation, memory and communication capability often due to power constraints; c) the nodes typically communicate using a short range ad hoc communication network; d) the nodes are commonly installed in remote or other environments that preclude normal communication and control of the devices; and e) the nodes are often inexpensive. Sensor nodes are generally expected to be long-lived (deployed for years), un-tethered (both in terms of communication and power), and unattended (and so are capable of self configuring and self-adapting).

Sensor nodes may have capability of measuring at least one characteristic in their environment, such as detecting ambient conditions (e.g., temperature, humidity, movement, sound, light, or the presence or absence of certain objects). Many potential applications of wireless sensor networks exist, including as example of physiological monitoring, environmental monitoring, condition-based maintenance, military surveillance, precision agriculture, geophysical monitoring, and/or monitoring various other types of events.

While individual sensor nodes may have limited functionality, the global behavior of the wireless sensor network can be quite complex. The information collection apparatus may be a mobile station connectable to an existing communication network such as the Internet.

Typically, the primary resource constraint of sensor nodes in sensor networks is energy. Because many sensor networks deploy sensor nodes that are battery powered and that can scavenge only a small amount of energy from their surroundings, limited battery power is one of major hurdles in achieving desired longevity of network operation. Reducing power consumption of the wireless sensor networks has been a topic of extensive study. The problem has not been completed resolved.

In some applications, it is required that the information collection network comprising sensor nodes with a local storage capability. In some other applications, the information collection system may comprise nodes with local storage capability only. A RFID system is an exemplary case of such applications. It is therefore desired that the information collection system has the flexibility for all such applications.

It is therefore an object of the present invention to provide a low power consumption wireless information collection system comprising wireless sensor nodes that achieves longevity of the operation with a conventional battery.

It is another object of the present invention to provide a low power consumption wireless information collection system comprising nodes with local storage unit that achieves longevity of the operation with a conventional battery.

It is yet another object of the present invention to provide a novel power management method for the wireless information collection system comprising a plurality of data collection devices (nodes) and an information collection apparatus. The devices are in a “switch-off” status until they receive the RF energy transmitted from the information collection apparatus.

### SUMMARY OF THE INVENTION

In an exemplary embodiment, a sensor node comprises a sensor, a processor, a transceiver, a RF energy receiver, and a switch. The sensor node may be powered by a battery. A plurality of sensor nodes may be deployed in an area of interests. The sensor nodes are at a “switch-off” status to reserve the battery power until the nodes are activated by an information collection apparatus.

The apparatus may comprise a RF energy generator and a transceiver conforming to the same communication standards as the sensor nodes. The apparatus may also comprise second transceiver for communicating with an existing communication network such as the Internet. The apparatus may be installed in a vehicle.

To activate the information collection system, the RF (radio-frequency) energy generated by the apparatus is transmitted in the area of the interests with pre-deployed sensor nodes. The RF energy receiver in the sensor nodes receives the electromagnetic energy by an antenna and converts the energy into a DC (direct-current) voltage. If the DC voltage is in exceeding of a threshold voltage of a switch, the battery power is directed to supply the operation of the sensor nodes. The nodes are activated. The sensor nodes will remain at the “switch-on” status even after the RF energy from the apparatus is switched off. A switch controller is used to maintain the switch at the “switch-on” status by drawing a current from the power supply to maintain the input voltage for the switch.

An ad hoc communication network comprising sensor nodes and information collection apparatus is then established. The data collected by sensors is sent to the information collection apparatus through the ad hoc network. The apparatus may send an instruction to sensor nodes to switch off the battery power after the completion of an information collection task. The apparatus may also send the collected data to a server through the existing communication network.

In another embodiment, the information collection system comprises at least a node without a sensor. The node may comprise a data storage unit with pre-stored data. After the node is activated, the data stored may be read out and be sent to the apparatus through the ad hoc communication network.

In yet another embodiment, the node may comprise a sensor and a storage unit with pre-loaded data. Data collected by the sensor and the data read out from the local storage unit may be sent in combination to the apparatus after the ad hoc communication network is established.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram of a data collection device (node of the network) in three different embodiments.

FIG. 2 is a schematic diagram of an exemplary information collection apparatus.

FIG. 3 is a schematic diagram of depicting functional blocks for converting a received RF energy into a DC voltage and for supplying the battery power to the data collection devices.

FIG. 4 is a schematic functional block diagram of the information collection system.

FIG. 5 is a flow diagram depicting steps of the operation of the information collection system.

FIG. 6 is a flow diagram depicting steps of the power management method of the information collection system.

FIG. 7 is a schematic functional block diagram of the information collection system in one embodiment as a wireless sensor network.

FIG. 8 is a schematic functional block diagram of the information collection system in another embodiment as an active RFID system with low power consumption.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

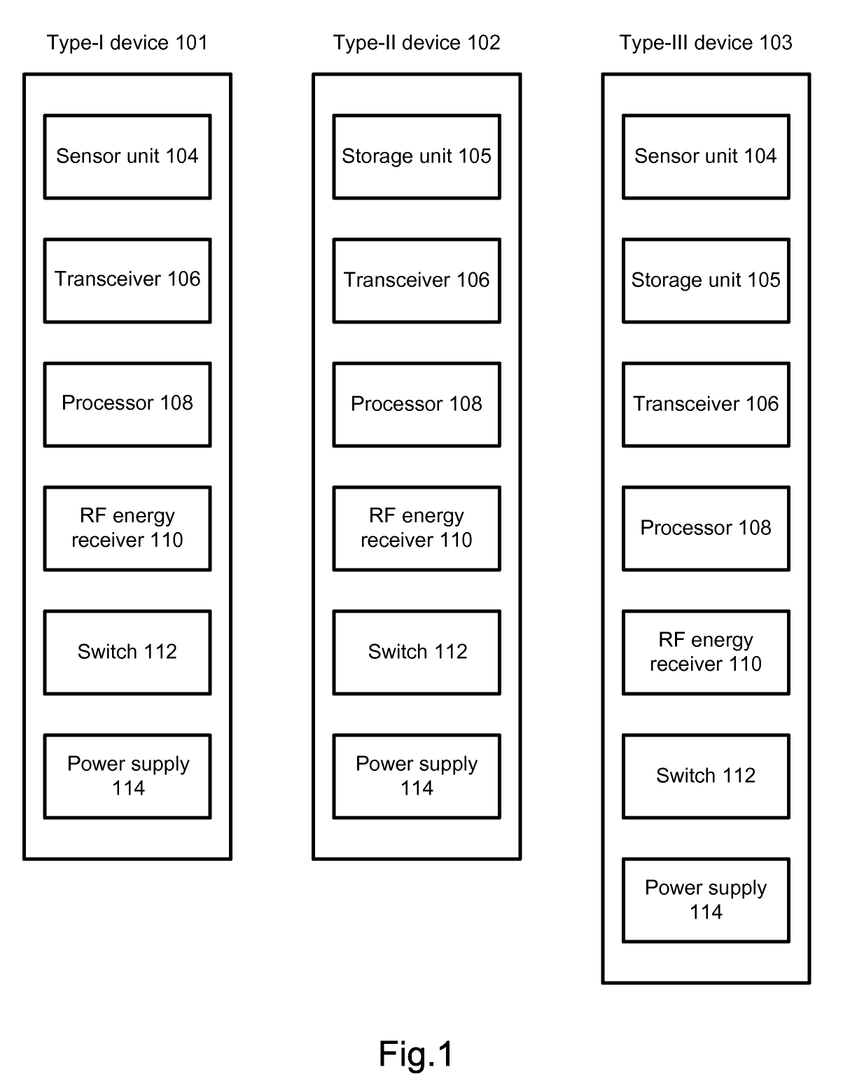

FIG. 1 is a schematic diagram of a data collection device (node of network) in three different embodiments. Type-I device 101 comprises a sensor unit 104, a transceiver 106, a processor 108, a RF energy receiver 110, a switch 112, and a power supply 114. 104 may comprise one sensor for measuring a characteristic of its environment such as temperature, humidity, movement, sound, light, or the presence or absence of certain objects. 104 may comprise a plurality of sensors for measuring different characteristic of their environment. The transceiver 106 is for the data collection device 101 to communicate with another device or with an information collection apparatus. 106 may conform to a short range communication standard such as the Bluetooth (IEEE 802.11b and its amendments), or the ZigBee (IEEE 802.15.4 and its amendments), or the WiFi (IEEE 802.11 and its amendments). The processor 108 may comprise an analog-to-digital converting circuits for converting an analog signal from the sensor to a digital signal, a digital signal processor and/or a CPU (central processing unit). The RF energy receiver 110 receives an external RF energy and converts the received energy into a DC voltage. The switch 112 with a “switch-on” threshold voltage is used to control the power supply 114. If the DC voltage resulting from the received RF energy is in exceeding of the threshold voltage, the switch 112 directs the power supply 114 to provide energy for the operation of the device 101. According to one implementation, the power supply 114 is a battery. The power supply 114 may be a solar panel in another implementation. The power supply 114 may be an energy harvesting device in yet another implementation.

As illustrated in FIG. 1, type-II device 102 is similar to the type-I device 101 except that the sensor unit 104 is replaced by a data storage unit 105. 105 may be a semiconductor memory such as a flash memory or a plurality of flash memories. 105 may be pre-loaded with data before it is deployed to the field (an area of interest).

As further illustrated in FIG. 1, type-III device 103 comprises a sensor unit 104 and a storage unit 105. 103 may be used to collect data via the sensor unit 104. The collected data from the sensor unit 104 and the data read out from the storage unit 105 may be sent in combination through the ad hoc communication network to the information collection apparatus.

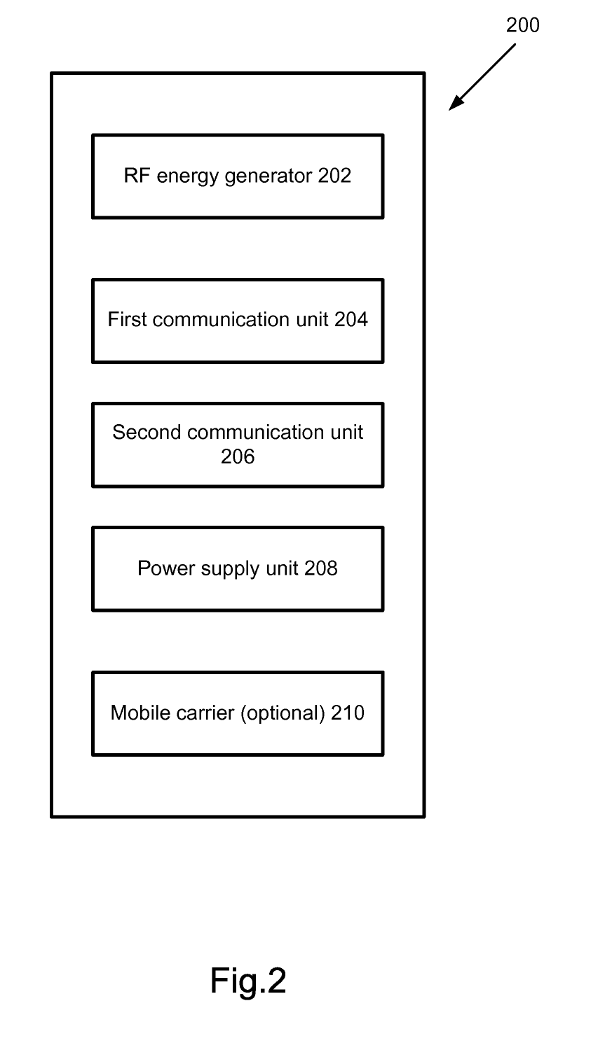

FIG. 2 is a schematic diagram of the information collection apparatus 200. The apparatus 200 collects information from data collection devices after the devices and the apparatus form an ad hoc communication network. The apparatus 200 comprises a RF energy generator 202, a first communication unit 204, a second communication unit 206, and a power supply unit 208. The apparatus 200 may be installed in a mobile carrier 210 such as for example, in a vehicle.

The RF energy generator 202 generates an electromagnetic energy in RF band. The generated RF energy is transmitted to the area of interests with the pre-deployed data collection devices. The first communication unit 204 may conform to the same short range communication standard as the transceiver 106 in the data collection devices. The second communication unit 206 may be another transceiver for communicating with an existing communication network such as for example, the Internet. The power supply unit 208 may be a battery.

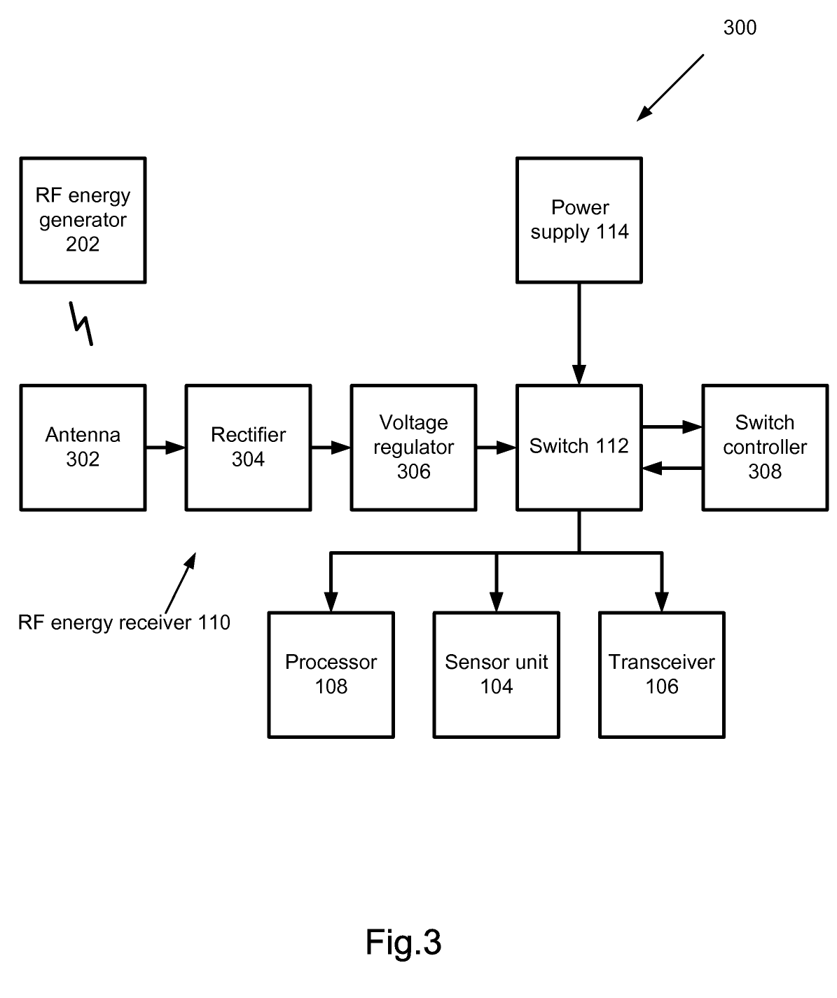

FIG. 3 is a schematic diagram of depicting functional blocks for converting received RF energy into a DC voltage and for controlling the battery power to provide energy for the operations of the data collection device. The RF energy generator 202 generates the RF energy and transmits the energy into the area of interests. A plurality of devices may have already been deployed in the area. The antenna 302 may be of inductive type or be of a dipole type depending on the frequency of the RF energy. The high frequency RF energy requires a dipole type of antenna. The rectifier 304 converts at least a portion of the received RF energy into a DC component. The voltage regulator 306 converts the DC component into a DC voltage. The DC voltage turns on the switch 112 if it is in exceeding of its “switch-on” threshold. A switch controller 308 is used to ensure the switch 112 to be maintained at the “switch-on” status even after the RF energy is switched off. In one implementation, the controller 308 may draw a current from the power supply 114 to assist to charge up an output capacitor of the voltage regulator 306 after the switch 112 is switched on. After the external RF energy source 202 is switched off, the voltage regulator 306 ceases to provide a stable output voltage. However, the current source controlled by the controller 308 will provide a current and a stable voltage to maintain the switch at the “switch-on” status. The power supply 114 provides power for the operation of the sensor 104, the transceiver 106 and the processor 108 in an exemplary implementation as illustrated in FIG. 3.

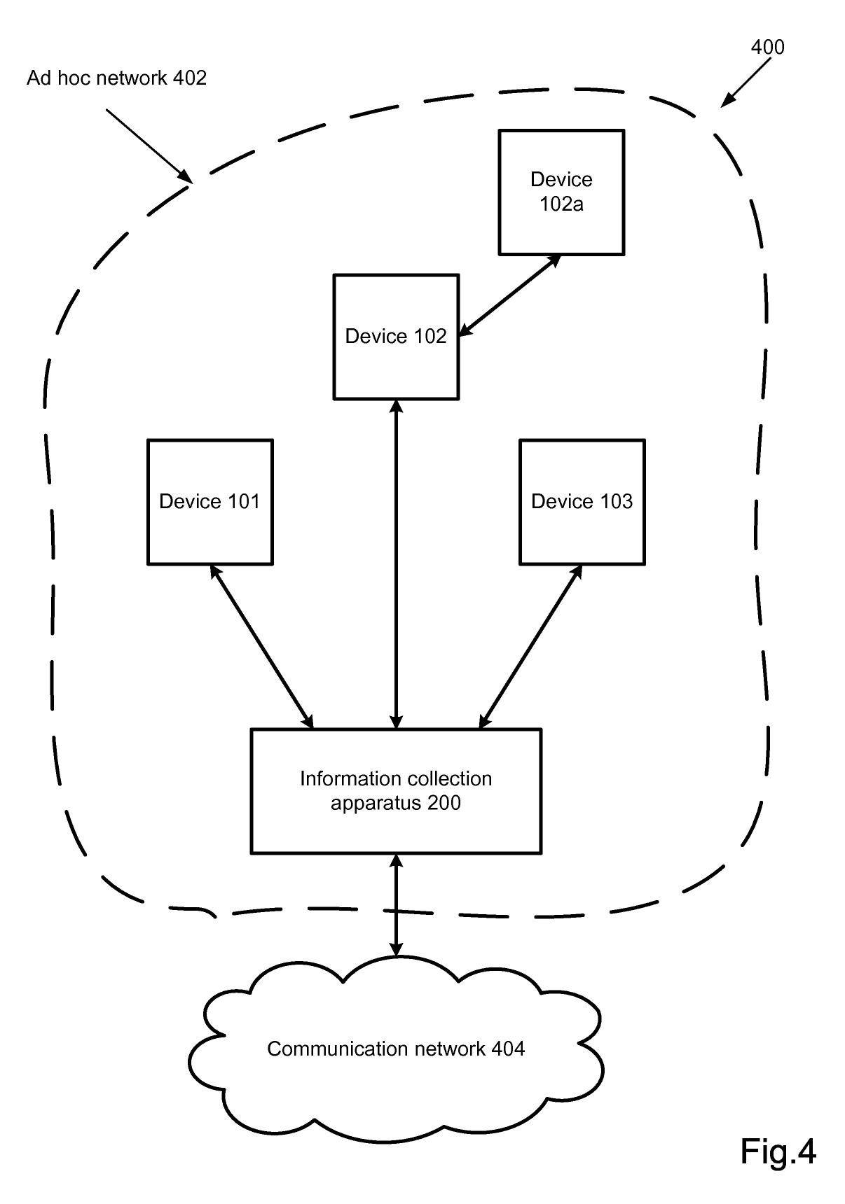

FIG. 4 is a schematic functional block diagram of the information collection system 400. The system 400 comprises the information collection apparatus 200, a type-I device 101, type-II devices 102 and 102a, and a type-III device 103. The devices may be connected to the apparatus 200 directly. The device may also be connected to the apparatus 200 through another device in the ad hoc communication network 402. The information collection system 400 may comprise one type of devices and the system may also comprise all three types of devices. The apparatus 200 with the second communication unit 206 may be connected to an existing communication network 404. 404 may be the Internet in an exemplary case. The data collected from each device (node) by the apparatus 200 may be sent to a server in the communication network 404. Although one information collection apparatus is depicted in FIG. 4, the system 400 may comprise a plurality of apparatus and many devices. It should be noted that devices (nodes) are kept at the status of “switch-off” until the apparatus 200 sends out the RF energy as a triggering signal. The apparatus 200 has the capability of switching on and off the devices (nodes) of the information collection system.

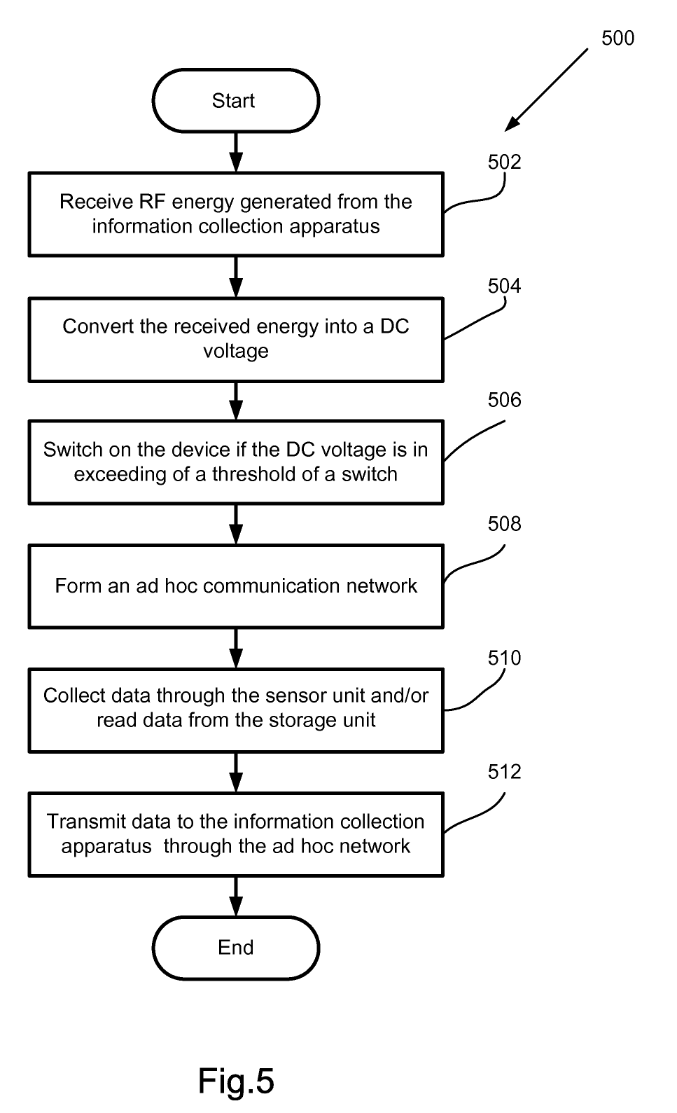

FIG. 5 is a flow diagram depicting steps of the operation of the information collection system. Process 500 starts with a step 502 that a device (node) receives RF energy generated from an information collection apparatus 200. The RF receiver 110 in the device converts the received RF energy into a DC voltage in step 504. The device is switched on in step 506 if the DC voltage resulting from the received RF energy is in exceeding of the threshold voltage of the switch 112. An ad hoc communication network (link) 402 is formed in step 508 if at least one device is switched on. In step 510, data is collected by the sensor unit 104 and/or read out from the storage unit 105. The collected and/or readout data are transmitted to the information collecting apparatus 200 through the ad hoc communication network 402 in step 512.

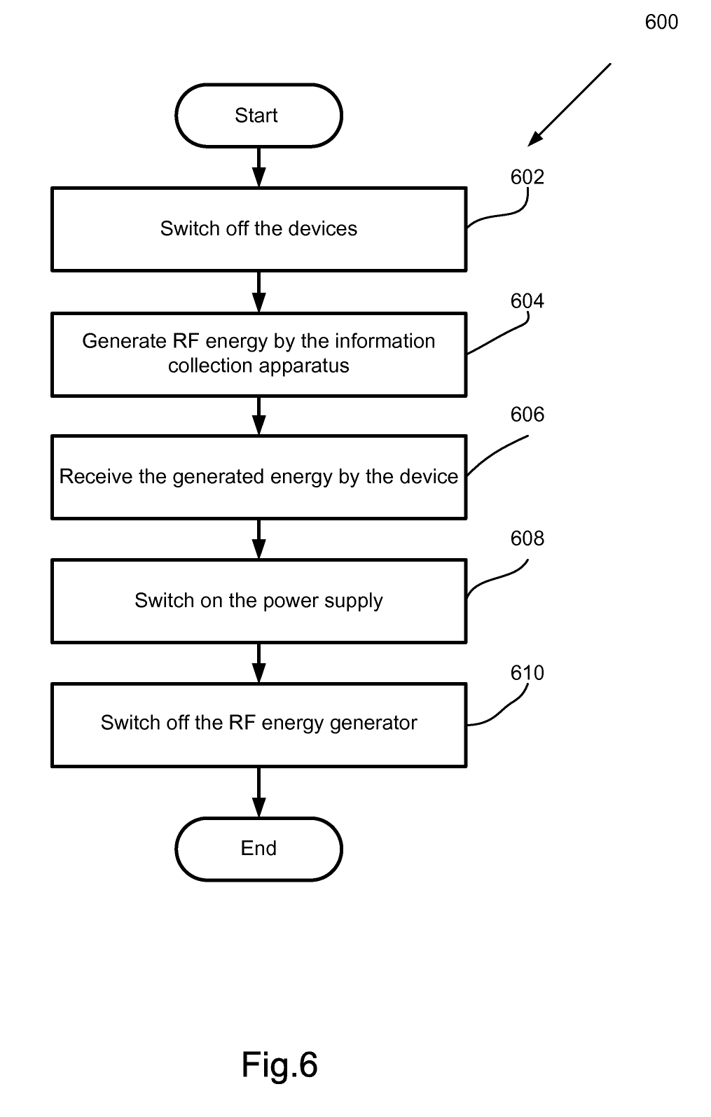

FIG. 6 is a flow diagram depicting steps of the power management method of the information collection system 400. Process 600 starts with step 602 that all devices (nodes) are at “switch-off” status. In step 604, an electromagnetic energy in RF band is generated by the information collection apparatus 200. The RF energy is received by a device (node) in step 606. The power supply 114 (battery) is switched on in step 608 if the received RF energy generates a DC voltage in exceeding of the threshold voltage of the switch 112. The RF energy generator is switched off in step 610. The device (node) will maintain at the “switch-on” status by using the switch controller 308 as described.

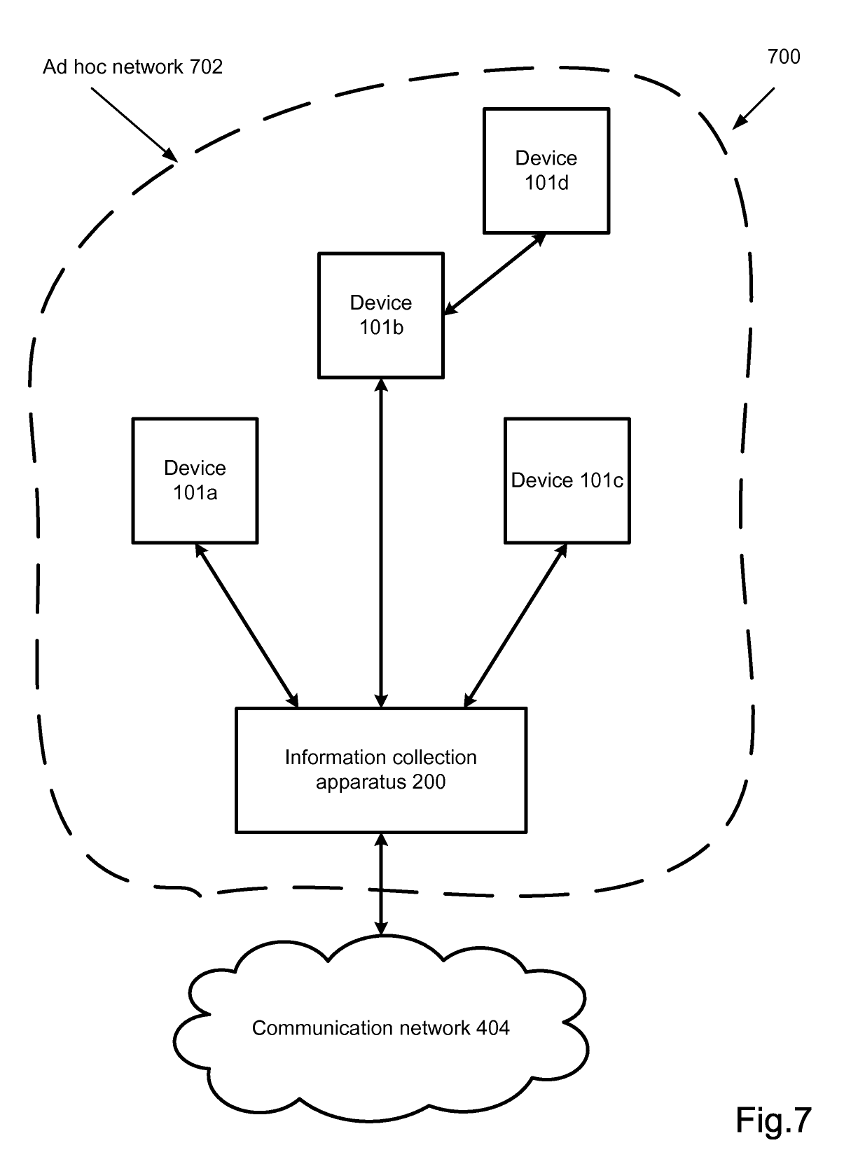

FIG. 7 is a schematic functional block diagram of the information collection system 400 in one embodiment as a wireless sensor network 700. The network 700 comprises a plurality of type-I devices (101a, 101b, 101c and 101d). Each device comprises at least one type of sensor. The devices are connected through an ad hoc communication network 702. At least some of the devices are connected to the information collection apparatus 200 directly. The wireless sensor devices (101a, 101b, 101c and 101d) are at the “switch-off” status until the information collection apparatus 200 sends out the RF energy. The present invention provides a low power consumption sensor network. The sensor units will only start to collect data after the apparatus sends out the RF energy. The sensor units will be at the “switch-off” status when the measurement data is not required. By implementing the present invention, the wireless sensors powered by a battery have the capability to be used for a very long period of time. Therefore, the replacement of the battery, which may be a costly and difficult task, can be avoided.

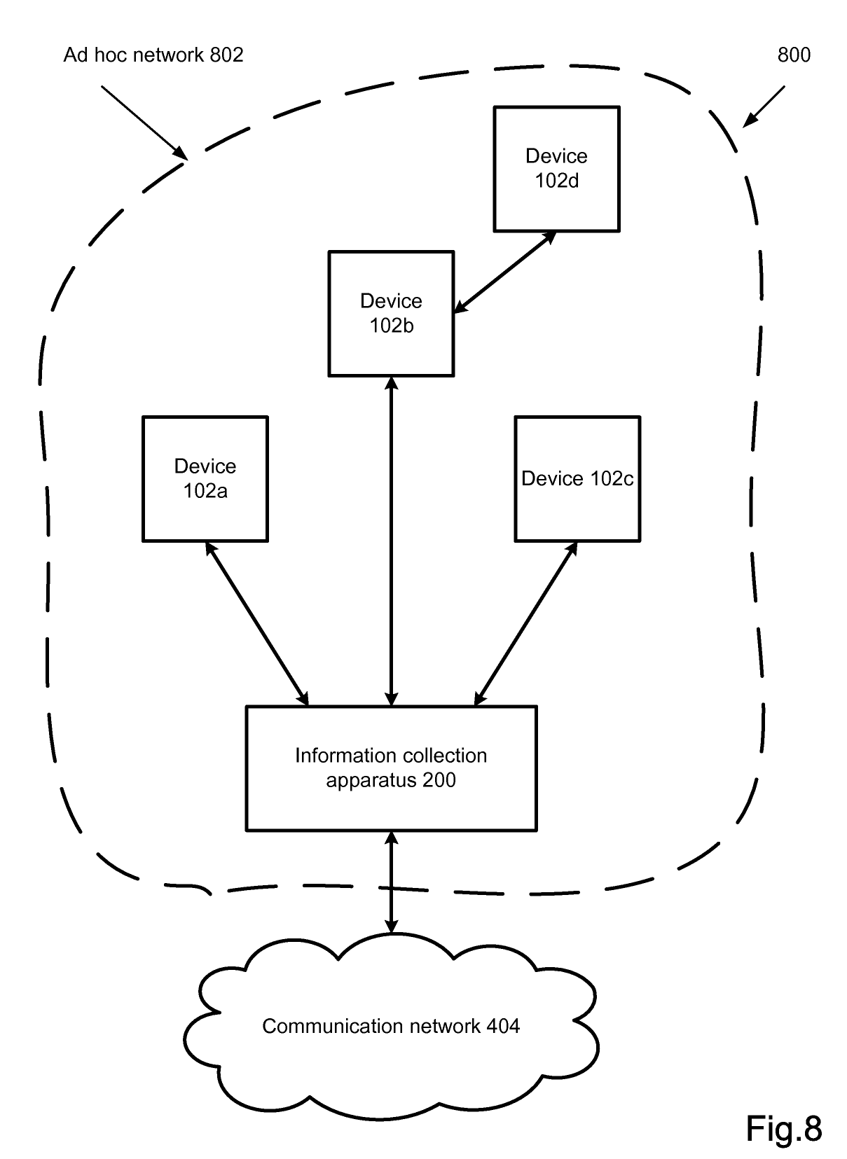

FIG. 8 is a schematic functional block diagram of the information collection system 200 in another embodiment as an active RFID system 800 with low power consumption. The system 800 comprises a plurality of type-II devices (102a, 102b, 102c, and 102d). Each device has a storage unit 105. All devices are at the “switch-off” status until the RF energy is received. The RF energy may be generated from the information collection apparatus 200. After receiving the energy and converting the energy into a DV voltage in exceeding of the threshold voltage of the switch 112, the battery power is directed by the switch to provide power for the operations of the devices (nodes). The devices may form an ad hoc communication network 802. At least some devices are connected to the apparatus 200 directly. The data stored in the devices may be read out and be transmitted to the apparatus 200. Although a battery is used, the battery lifetime may be extremely long since the battery power is consumed only when it is triggered by an external RF power. The ad hoc communication network 702 provides additional communication capability and flexibility in comparison to a conventional RFID system.

While the invention has been disclosed with respect to a limited number of embodiments, numerous modifications and variations will be appreciated by those skilled in the art. It is intended that all such variations and modifications fall within the scope of the following claims:

1. An information collection system comprising:
(a) a plurality of data collection devices comprising a radio-frequency energy receiving unit; and
(b) an information collection apparatus comprising a radio-frequency energy generator,
wherein said device and said apparatus are connectable through an ad hoc communication network and said devices are at “switch-off” status until a radio-frequency energy generated by the generator of the apparatus is received by the receiving unit of the devices.

2. The system as recited in claim 1, wherein said devices further comprising:
(a) at least one sensor; and/or
(b) a data storage unit.

3. The system as recited in claim 1, wherein said devices further comprising:
(a) a power supply unit;
(b) a data processor; and
(c) a wireless communication transceiver.

4. The device as recited in claim 3, wherein said transceiver is selected from a device conforming to a standard or a combination of standards from the following group:
(a) ZigBee (IEEE 802.15.4 and its amendments);
(b) Bluetooth (IEEE 802.11b and its amendments); and
(c) WiFi (IEEE 802.11 and its amendments).

5. The device as recited in claim 1, wherein said radio-frequency receiving unit further comprising:
(a) an antenna for receiving the radio-frequency energy;
(b) a rectifier for converting the received energy into a direct-current component; and
(c) a regulator for converting the direct-current component into a voltage.

6. The system as recited in claim 1, wherein said apparatus further comprising a communication unit conforming at least to the same communication standard (s) as said device's.

7. The system as recited in claim 1, wherein said apparatus comprising a means of connecting to an existing communication network.

8. The system as recited in claim 1, wherein said apparatus is a mobile station.

9. A method of collecting information through an information collection system comprising a plurality of data collection devices and an information collection apparatus, the method comprising:
(a) receiving by said devices a radio-frequency energy generated by said apparatus;
(b) switching on said devices;
(c) forming an ad hoc communication network comprising said devices and said apparatus; and
(d) transmitting collected and/or stored data from said devices to the apparatus through the ad hoc communication network.

10. The method as recited in claim 9, wherein said method further comprising a means of switching off said devices based upon a control signal sent from said apparatus.

11. The method as recited in claim 9, wherein said devices further comprising a means of converting the received radio-frequency energy into a direct-current voltage and a means of switching on a power supply unit of said device if said voltage is in exceeding of a threshold of a switch in said devices.

12. The method as recited in claim 9, wherein said devices further comprising a means of measuring at least one characteristic of its environment by at least one sensor.

13. The method as recited in claim 9, wherein said devices further comprising a means for forming an ad hoc communication network with nearby devices conforming to a standard or a combination of standards from the following group:
(a) ZigBee (IEEE 802.15.4 and its amendments);
(b) Bluetooth (IEEE 802.11b and its amendments); and
(c) WiFi (IEEE 802.11 and its amendments).

14. A method of power management of an ad hoc network comprising a plurality of data collection and/or storage devices and an information collection apparatus, the method comprising:
(a) generating a radio-frequency energy by said apparatus;
(b) receiving the generated energy by said devices;
(c) switching on a power supply unit by a switch of said devices; and
(d) providing power from the power supply unit for collecting, processing and transmitting data.

15. The method as recited in claim 14, wherein said step of “switching on” is triggered by a direct-current voltage in exceeding of a threshold voltage of a switch.

16. The method as recited in claim 15, wherein said direct-current voltage is an output of a radio-frequency energy receiver comprising an antenna, a rectifier and a voltage regulator.

17. The method as recited in claim 15, wherein said methods further comprising a means of maintaining the switch at the “switch-on” status after said radio-frequency energy is switched off.

18. The method as recited in claim 17, wherein said means of maintaining the switch at the “switch-on” status is achieved by a switch controller that provides a means of sustaining the input voltage of the switch.

19. The method as recited in claim 14, wherein said method further comprising a step of switching off said devices based upon a signal sent from said apparatus.

20. The method as recited in claim 14, wherein said power supply unit is a battery.
